(19) United States
(12) Patent Application Publication
(10) Pub. No.: US 2017/0028327 A1
(43) Pub. Date: Feb. 2, 2017

(54) Fluid Filtration Assembly with Locking/Unlocking of the Filter Body

(71) Applicant: Cummins Filtration Sarl, Quimper (FR)

(72) Inventors: Erwan Guyomard, Loc Brevalaire (FR); Anthony Barreteau, Quimper (FR); Emmanuel Page, Tremeoc (FR)

(73) Assignee: Cummins Filtration Sarl, Quimper (FR)

(21) Appl. No.: 15/302,786

(22) PCT Filed: Apr. 1, 2015
(86) PCT No.: PCT/EP2015/057269

§ 371 Date: Oct. 7, 2016

(30) Foreign Application Priority Data
Apr. 14, 2014 (FR) 1453313

(51) Int. Cl. B01D 35/30; E05C 5/04; B01D 46/00

(52) U.S. Cl. CPC B01D 35/30; B01D 46/0002; E05C 5/04; B01D 2201/30; B01D 2265/028

(57) ABSTRACT

The present invention relates to a filtration assembly for filtering a fluid flowing in particular in a motor or a hydraulic equipment, comprising: —a filter body having a tank and a cover, the filter body being intended to house a filter cartridge, —at least one locking system for the filter body, being movable between a locking position and an unlocking position, wherein said filtration assembly has means for holding the locking system (5) in the unlocking position.

### CROSS-REFERENCE TO RELATED APPLICATIONS

The present application is a U.S. national stage application claiming the benefit of International Application No. PCT/EP2015/057269, filed on Apr. 1, 2015, which claims the benefit of and priority to French Patent Application No. 1453313, filed Apr. 14, 2014. The contents of both applications are incorporated herein by reference in their entirety.

### FIELD OF THE INVENTION

The field of the invention is that of filtration assemblies for filtering a fluid such as fuel, an oil, or air flowing in particular in a motor or a hydraulic equipment.

### PRIOR ART

Filtration assemblies generally comprise a filter body comprising a tank or shell and a cover or head. When the filtration assembly is in use, the filter body is closed, the cover and tank cooperating with one another to form a seal and close the filter body. The filter body is configured for housing a filter cartridge.

When maintaining the filtration assembly, the filter cartridge is generally changed after the has been opened. To effect the closing of the filter body during the maintenance operation or during the installation of the filtration assembly, an additional locking system can be provided for the filter body in order to secure the closing of the filter body and/or to ensure that it is sealed, for example, by reinforcing the tightening between the tank and the cover.

The locking system is unlocked during a maintenance operation.

A disadvantage of such a locking system resides specifically in the fact that it can interfere with the work space of the user during the maintenance of the filtration assembly and sometimes even with the closing of the filter body after maintenance.

### AIMS OF THE INVENTION

The object of the invention is to provide a filtration assembly that can be maintained quickly and in a secure manner.

According to at least one embodiment in particular, the object of the invention is to provide such a filtration assembly that makes it possible to free the workspace of the user during a maintenance operation.

According to at least one embodiment, another object of the invention is to provide such a filtration assembly that makes it possible to ensure that the locking system is correctly positioned to allow effective locking of the filter body after a maintenance operation.

### DESCRIPTION OF THE INVENTION

In order to achieve all or part of these objects, the invention proposes a filtration assembly for filtering a fluid flowing in particular in a motor or a hydraulic equipment, comprising:
a filter body having a tank and a cover, the filtration body being intended to house a filter cartridge,
at least one locking system of the filter body, being movable between a locking position and an unlocking position.

According to the invention, the filtration assembly comprises means for holding the locking system in the unlocked position.

The holding means thus enable a reversible securing of the locking system.

Owing to the invention, provision is made of means making it possible to keep the locking system from interfering with the user's workspace, specifically during a maintenance operation or during the installation of the filtration assembly.

Hence owing to the invention, the user can use the holding means of the locking system after unlocking, for example, to secure the latter. Once the maintenance operation or installation of the filtration assembly is complete, the user can, for example, disengage the locking system from the holding means after closing the filter body in order to lock the filtration assembly. The locking system or systems will not interfere with the user during the installation or maintenance operation.

Moreover, owing to the invention, during the closing of the filter body after the maintenance operation or installation, the user can be certain that the locking system will not become wedged in the space between the tank and the cover and interfere with the closing of the filter body or even damage the closing mechanism of the filtration assembly.

Advantageously, the holding means are configured such that the locking system can be fastened to or disengaged from the holding means with just one hand and without requiring any tools.

The holding means cooperate, for example, with the locking system by snap-in and/or by friction, by mechanical stopping, fixed or detachable stop. An advantage of such holding means lies in making it possible to fasten as well as disengage the locking system easily, in particular with just one hand and/or without tools.

The locking system can have at least one actuator and one locking element. The actuator, which is integrally formed with the cover or the tank, respectively, is configured, for example, for bringing the locking element into the locking position and for the release thereof. The locking element is configured, for example, so that it can be secured in a reversible manner to the tank or to the cover, respectively, in order to effect the locking of the filter body.

In an embodiment, the actuator and the locking element are linked to one another by a mechanical articulation, for example, a knuckle joint, consisting specifically of mechanical articulation about two separate axes, which are arranged parallel to one another, or not.

In a special embodiment, the mechanical articulation between the actuator and the locking element takes place about a single axis.

In another embodiment, the actuator and the locking element are made of a single piece forming all or part of the locking system. In the latter case, the locking system in particular has a single piece forming the actuator and the locking element, wherein the piece is configured, for example, to be movable at least in rotation about a single axis in order to effect the locking by cooperating in a reversible manner with the tank or cover, respectively, and, by rotation about said axis, to move into the unlocking position and to be able to cooperate with the holding means.

In an example, the holding means are configured, for example, for holding the locking element in the unlocking position.

In another example, the holding means are configured, for example, for holding the actuator in the unlocking position.

When provision is made of a knuckle joint, the latter can comprise a first axis fixed in relation to the cover or to the tank, respectively, about which axis the actuator is at least partially movable in rotation, the knuckle joint comprising, for example, a second axis, parallel or not, to the first axis and fixed in relation to the actuator, the locking element being at least partially movable in rotation about said second axis.

The locking element can have a fastening part, which in a special example can be in the form of a hook, on one end and the tank or the cover, respectively, can have a part corresponding to the fastening part such as a rim or a groove or even a rib configured to enable the retention of the fastening part in the locking position.

The holding means are advantageously formed in or on the cover or in or on the tank, respectively.

In one embodiment, the locking element and/or the actuator of the locking system have/has at least one wire, specifically a metal wire, and/or a plate, specifically a metal or polymer, in particular elastomer plate.

When the locking element of the locking system has at least one wire, at least one of the (e.g., essentially parallel) two wire portions can be configured such that they can be held, on the outside and/or on the inside, by the holding means in the unlocking position.

When the locking element and/or the actuator comprise/comprises a plate, the holding means can be configured for holding one or two sides, specifically opposite sides, of said plate, in particular by snap-in.

Another object of the invention, in combination with the aforementioned, is a method for maintaining/installing the filtration assembly as defined above, said method comprising the following steps:
unlocking the locking system or each locking system,
securing the locking system to the holding means,
opening the filter body,
performing the maintenance operation/installation of the filtration assembly,
closing the filter body,
disengaging the locking system from the holding means,
locking the locking system or each locking system.

### LIST OF FIGURES

Other features and advantages of the invention will appear upon reading the following description of specific embodiments, provided as a mere illustrative and non-limiting example, in the appended drawings, in which:

FIG. 1 is a schematic illustration of a filtration assembly of the invention in the locking position, in a perspective view;

FIG. 2 is a schematic illustration of the filtration assembly of FIG. 1 in the unlocking position, in a perspective view;

FIG. 3 is a partial, schematic, longitudinal sectional view of the filtration assembly of FIG. 1;

FIG. 4 shows, in a schematic and partial manner and in perspective, a locking system and means for holding a filtration assembly of the invention in the holding position of the locking system;

FIG. 5 is a schematic, perspective, lateral view of the locking system and holding means of FIG. 4, still in the holding position of the locking system;

FIG. 6 shows, in a schematic and partial manner and in perspective, the example of the holding means of FIGS. 4 and 5;

FIG. 7 shows, in a schematic and partial manner and in perspective, another example of the holding means with the locking system removed;

FIG. 8 shows, in a schematic and partial manner and in perspective, another example of the holding means with the locking system removed;

FIG. 9 shows, in a schematic and partial manner and in perspective, another example of the holding means secured to a locking system;

FIG. 10 shows, in a schematic and partial manner and in perspective, another example of the holding means secured to a locking system;

FIG. 11 shows, in a schematic and partial manner and in perspective, another example of the filtration assembly of the invention in the locking position of the locking system;

FIG. 12 shows, in a schematic and partial manner and in perspective, the filtration assembly of FIG. 11 in the unlocking position of the locking system;

FIG. 13 shows, in a schematic manner, another example of the filtration assembly in the locking position of the locking system;

FIG. 14 shows, in a schematic and partial manner and in perspective, the filtration assembly of FIG. 13 in the process of being unlocked;

FIG. 15 shows, in a schematic and partial manner and in perspective, the filtration assembly of FIGS. 13 and 14 in the unlocked position of the locking system;

FIG. 16 shows a detail of FIG. 15 illustrating the holding means secured to the locking system;

FIG. 17 shows, in a schematic and partial manner and in perspective, another example of the filtration assembly of the invention in which the holding means are not secured to the locking system;

FIG. 18 shows, in a schematic and partial manner and in perspective, the filtration assembly of FIG. 17, the holding means being secured to the locking system in this figure;

FIG. 19 is a highly schematic, partial, cutaway view of another example of the filtration assembly of the invention in the locked position of the locking system, and

FIG. 20 is a view similar to that of FIG. 19, in the unlocked position of the locking system.

### DETAILED DESCRIPTION OF THE INVENTION

A filtration assembly 1 for filtering a fluid flowing in, for example, a motor or a hydraulic equipment is illustrated in FIGS. 1-3. The fluid can consist of, for example, an oil or fuel.

The filtration assembly 1 comprises a filter body 2 comprising a cover 3 and a tank 4 configured for cooperating with one another in order to allow the closing of the filter body 2, specifically during the use of the filtration assembly 1, and to allow the opening of the filter body 2 during a maintenance operation, for example.

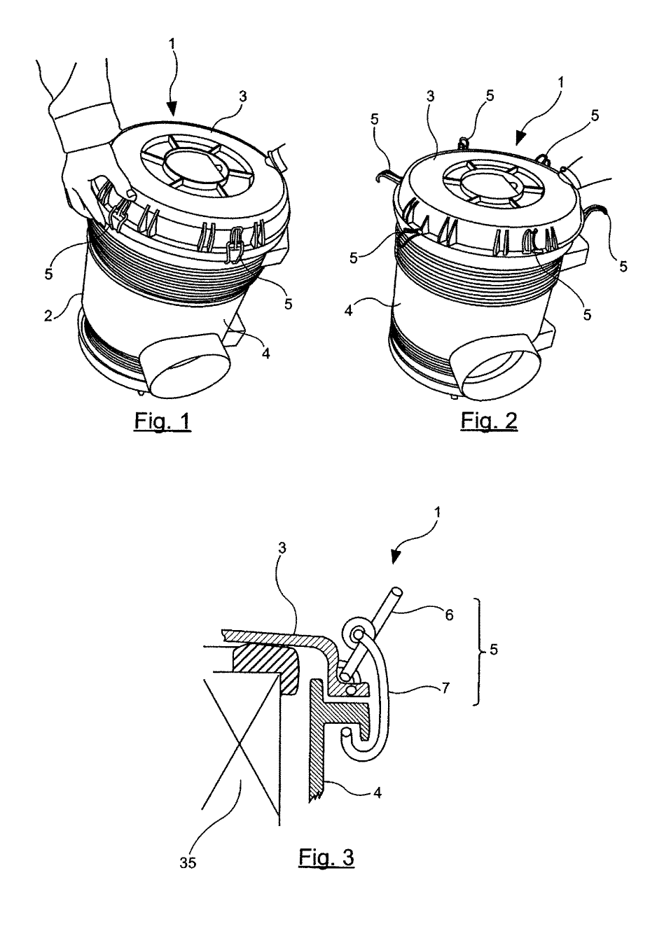

The filter body 2 is provided for housing a generally removable filter cartridge 35, which is partially visible in FIG. 3 and has the function of filtering the fluid.

The filtration assembly 1 furthermore has at least one locking system 5 for the filter body 2, in particular several locking systems 5 as in the illustrated example, in which there are five.

Each locking system 5 is being movable between a locking position discernible in FIG. 1 and also in FIG. 3, and an unlocking position discernible in FIG. 2.

According to the invention, the filtration assembly 1 comprises means 8 for holding the locking system in the unlocking position, as shall be described further below.

In the example illustrated in FIGS. 3-5, as can be seen, the locking system 5 has an actuator 6 and a locking element 7 linked to one another by a mechanical articulation, by a knuckle joint 9 in this example.

In this example, the actuator 6 is integral with the cover 3, but it could be integral with the tank 4 without exceeding the scope of the invention.

Also in this example, the actuator 6 is configured to allow the tightening and holding of the locking element 7 in the locking position, and inversely the transition of the locking element 7 into the unlocking position. The actuator 6 fulfills these two functions, in this example, by rotation in one direction and in the opposite direction of the actuator 6 in relation to the locking element 7, as shall be explained further below.

The locking element 7 in turn is configured to be secured in a reversible manner to the tank (to the cover in another example) in order to effect the locking of the filter body 2.

In the illustrated example, the locking system 5 has a wire, specifically, a metal wire.

In this example, the knuckle joint 9 has a first axis 10 fixed in relation to the cover 3, [sic] in this example. The actuator 6 is at least partially movable in relation to this first axis 10. In the illustrated example, an end part 17 of the actuator 6 forms this first axis 10. Indeed, in this example, the wire end part 17 is fastened onto the cover 3 but still movable in rotation in relation to the cover 3.

The knuckle joint 9 also comprises a second axis 30, which in this example is parallel to the first axis 10 and is formed in this example by an end part 31 of the locking element 7. The locking element 7 is movable in rotation about this second axis 30, whereas the actuator 6 is fixed in relation to the second axis 30. Indeed, the metal wire constituting the actuator 6 forms a turn 16 about the second axis 30 in two regions of said second axis 30, as illustrated and in this example. The two turns 16 form the link between the actuator 6 and the locking element 7.

The locking element 7 also comprises a fastening part 11, forming a hook in this example, conferring to the locking element 7 the capacity to secure the cover or the tank, respectively, during the locking of the filtration assembly 1 in the use position. In this example, the locking element furthermore has a linkage part 12, which in this embodiment consists of two wire portions 12a and 12b, which are essentially parallel in this example.

The actuator 6 of the locking system in turn has a handle part 15 permitting a user to rotation it in one direction or in an opposite direction in relation to the first axis 10. The two turns 16 connect the handle part 15 and the end part 17 of the actuator 6 to one another.

In this example, the holding means 8 formed on the cover 3 are arranged on either side of one of the wire portions 12, in this case the wire portion 12b, in such a way as to fix the wire portion 12b in a reversible manner, by friction in this example.

Also in this example, the handle part 15 of the actuator 6 is narrower than the clearance between the wire portions 12a and 12b such that the rotation of the locking element 7 in relation to the actuator 6 allows the passage of the locking element 7 from one side to the other of the actuator 6, specifically in the transition to and from the locking position and the unlocking position, when the locking element 7 is secured to the holding means 8 after having been disengaged from the tank 4.

When the locking system 5 is in the locked position, the locking element 7 is hooked in the example illustrated to the tank 4, for example, in a groove in the latter provided for this purpose. To unlock, the user rotates the actuator 6 about the first axis 10 in one direction. The user then unhooks the locking element 7 from the tank 4. The user then rotates the locking element 7 about the second axis 30 and fastens it to the holding means 8, which are on the cover 3 in this example. The user can then open the filter body and perform the maintenance operation or installation of the filtration assembly. The user closes the filter body 2 without the locking system 5 constituting a hindrance in his work space, owing to the invention. The user disengages the locking element 7 from the holding means 8. He then hooks the locking element 7 to the tank 4 by rotating the locking element 7 about the second axis 30 and inserting the fastening part 11 in, for example, the groove of the tank 4. The user tightens and locks the locking element 7 in the locking position, specifically by rotating the actuator 6 about the first axis 10 in an opposite direction.

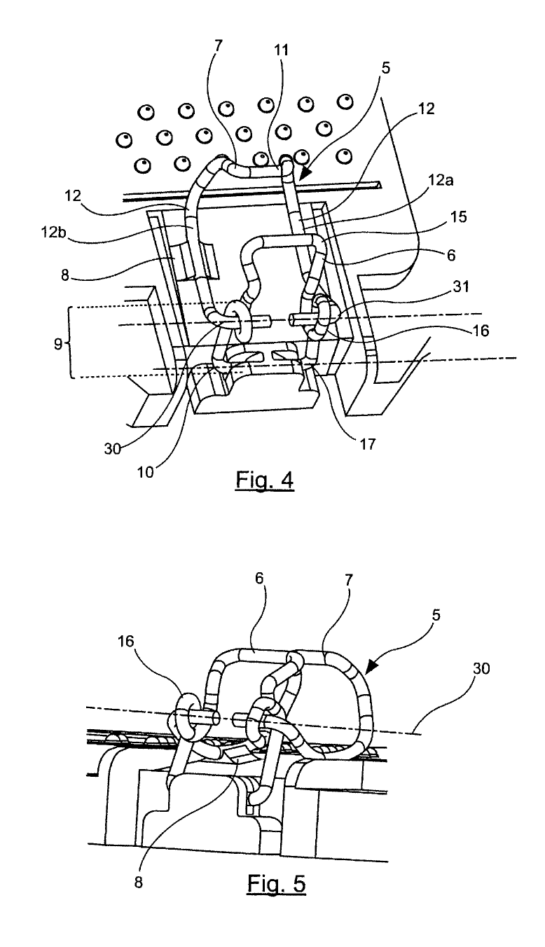

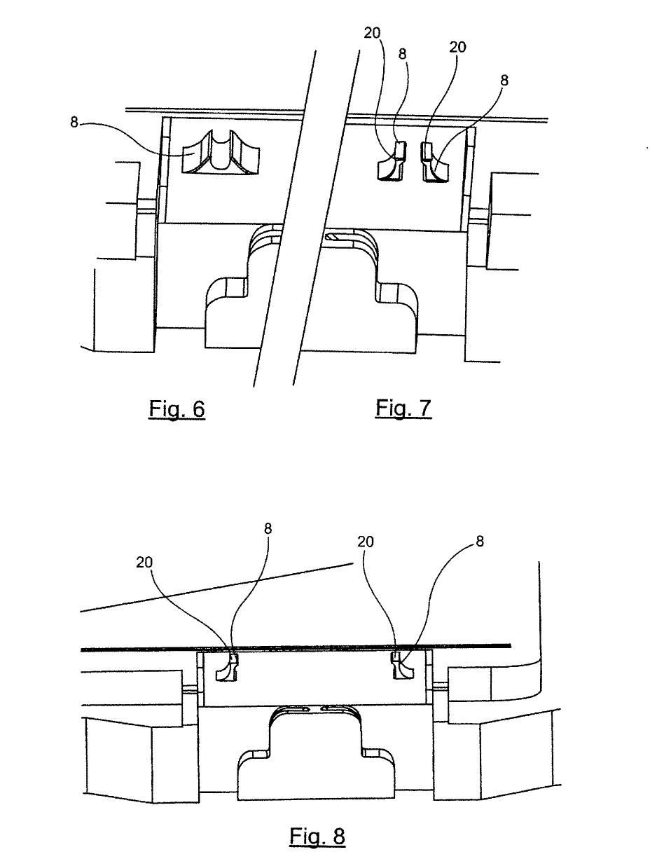

FIG. 6 shows separately the holding means 8 on the cover (or on the tank) of the embodiment of FIGS. 4 and 5.

Other examples of holding means 8 that can be used are illustrated in FIGS. 7 to 9.

In the example of FIG. 7, the holding means 8 are two in number, on the cover 3 or the tank 4, and permit the insertion of a wire portion, for example 12a or 12b, by snap-in. Indeed, as can be discerned, the holding means 8 have snapping tabs 20 with a certain degree of elasticity for allowing the movement thereof in order to enable the snap-in, the fastening, and the unsnapping of the locking element 7.

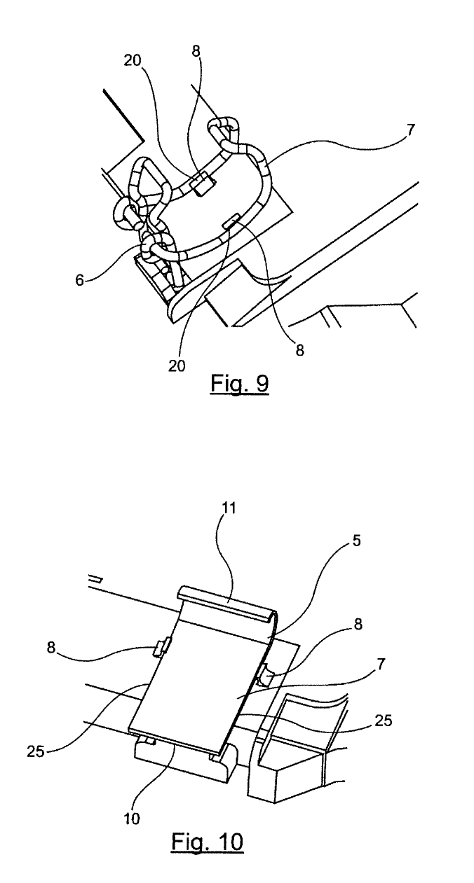

In the embodiment of FIG. 8, the holding means 8 are two in number, positioned outside the wire portions 12, and enable the locking element 7 of the locking system 5 to be snapped in place. It should be noted that each of the holding means 8 also has a snapping tab 20.

An embodiment in which the holding means 8 are arranged between the wire portions 12 and allow the locking element 7 of the locking system 5 to be snapped in place is illustrated in FIG. 9. In this example, each of the holding means 8 has a snapping tab 20.

Another example of the locking system 5 of the invention is shown in FIG. 10, which comprises a locking element 7 in the form of a plate rather than a metal wire. The plate has two opposite sides 25, which can be held by the holding means 8 by snap-in in this example, which means are two in number in this example, as shown. The actuator 6 is not visible in FIG. 9.

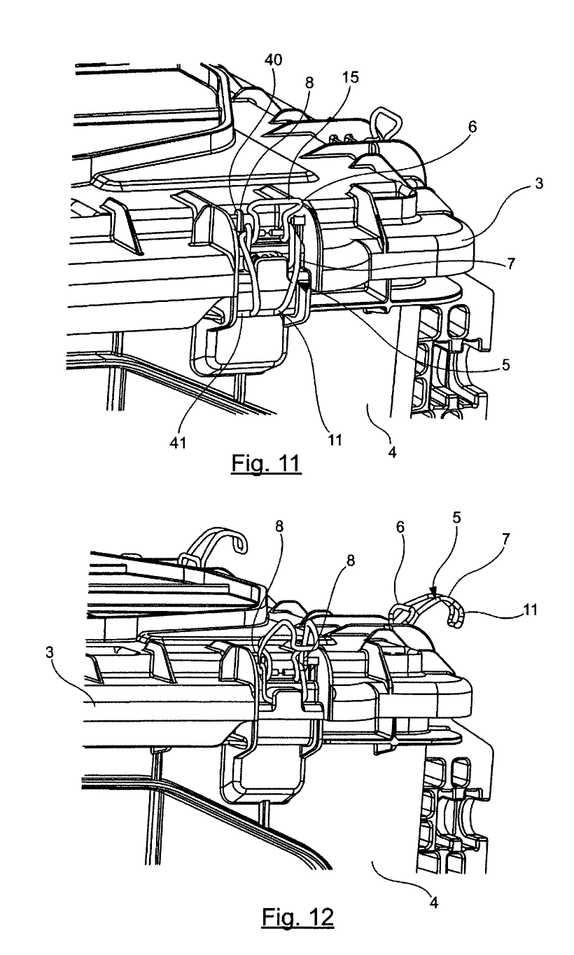

FIGS. 11 and 12 illustrate another embodiment of the invention. In this embodiment of the invention, the locking system is made with metal wires. The actuator 6, in its handle part 15, is greater in width than the clearance between the wire portions 12 of the locking element 7. In this example, it should also be noted that the wire portions 12a and 12b are not parallel but converge slightly towards the fastening part 11.

In this example, the wire portions 12 of the locking element 7 are curved. At least one notch 40, specifically two notches 40 in this example, formed on the cover 3 of the filtration assembly 1 constitute the holding means 8.

FIG. 11 illustrates the locking position in which the fastening part 11 is fastened to a rim 41 formed in the tank 4.

FIG. 12 illustrates the unlocking position, with the locking system 5 secured to the holding means 8 of the locking element 7, more precisely reversibly secured, specifically by friction in this example.

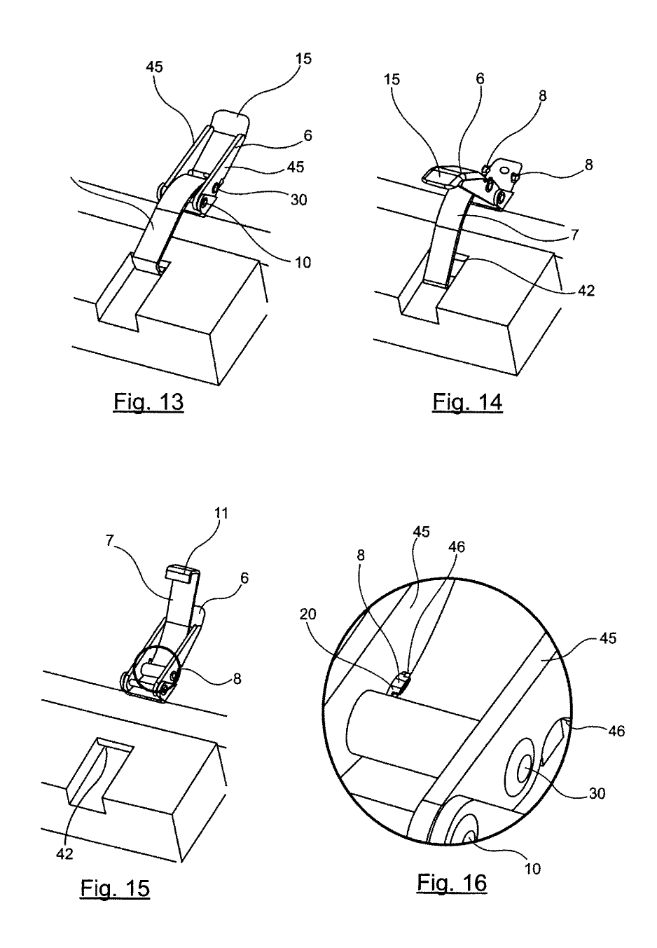

Another exemplary embodiment of the invention has been illustrated in FIGS. 13 to 16. In this example, the locking element is in the form of a metal plate with an end forming the fastening part 11, which locks in a groove 42 of the tank 4 or of the cover 3. The actuator 6 has a plate forming the handle part 15, which is surrounded by two supports 45 essentially perpendicular to the first and second axes 10 and 30, which they intersect.

The locking position is shown in FIG. 13. By rotating the actuator 6 in one direction, the locking element 7 is disengaged from the groove 42 and unhooked. A rotation of the locking element 7 and the actuator 6 in the opposite direction makes it possible to attain the position illustrated in FIG. 15 and to fasten the locking element 7 in the holding means 8, as can be discerned in FIG. 16 in particular. In this example, the holding means 8 form snapping tabs 20. The supports 45 of the actuator 6 have notches 46 for receiving the snapping tabs 20 of the holding means 8.

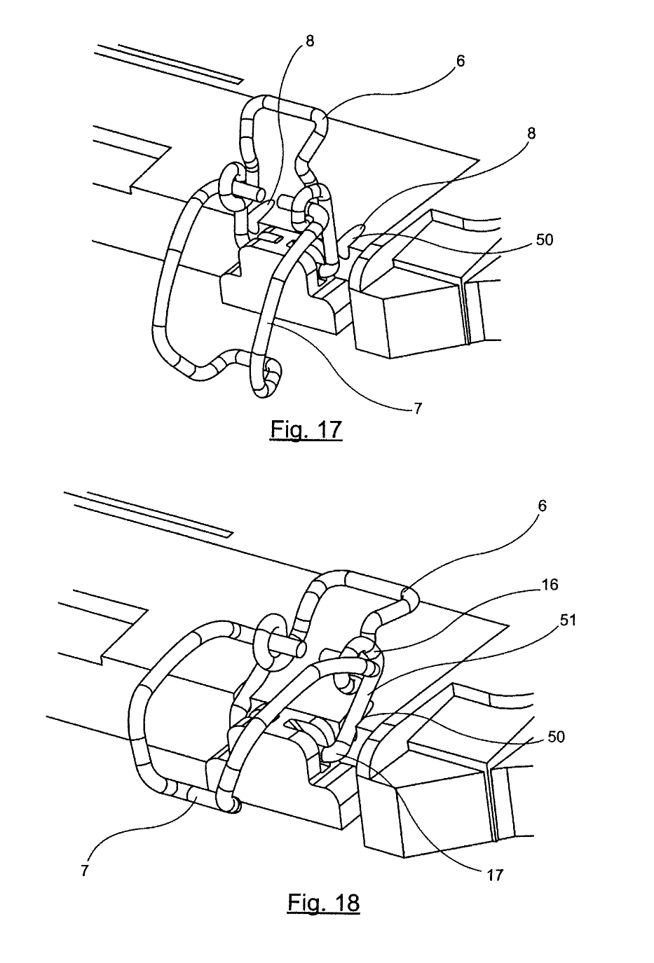

FIGS. 17 and 18 illustrate another embodiment in which the actuator 6 is secured in a reversible manner to the holding means 8, which in this example (as can be discerned in FIG. 18) are formed by notches 50 holding, by friction, two wire portions 51 of the actuator 6, wherein the wires 51 are formed in a region linking the turns 16 to the end part 17.

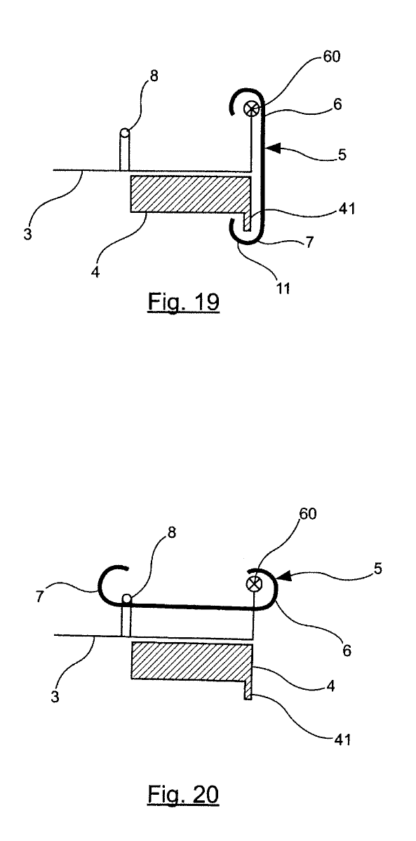

FIGS. 19 and 20 illustrate another embodiment of the invention in which the locking system 5 is formed from a single piece constituting both the actuator 6 and the locking element 7. This locking system 5 is configured to be movable at least in rotation about a single axis 60 during the transition from the locked position to the unlocked position and vice versa, and can be integral with the holding means 8.

The invention is not limited to the examples described.

In particular, the number of constituent pieces of the locking system can be other than one or two without exceeding the scope of the invention. In the case of a pivoting of the locking system about two axes, as in the case of the mechanical articulation comprising a knuckle joint, for example, the axes can be parallel to one another, as described previously, or not parallel to one another.

The mechanical articulation between the actuator and the locking element can take place about a single axis.

Throughout the description, the terms “having a” and “comprising a” are to be understood as synonyms of the expressions “having at least one” and “comprising at least one,” unless specified otherwise.

1-14. (canceled)

15. A filtration housing assembly for filtering a fluid, comprising:
a filter body having a tank and a cover, the filter body configured to house a filter cartridge;
at least one locking system coupled to the filter body, the at least one locking system movable between a locking position and an unlocking position; and
means for holding the locking system in the unlocking position.

16. The filtration housing assembly according to claim 15, wherein the holding means cooperates with the locking system by one of a snap-in engagement, a frictional engagement, a fixed mechanical stop, and a detachable mechanical stop.

17. The filtration housing assembly according to claim 15, wherein the locking system comprises at least one actuator and a locking element.

18. The filtration housing assembly according to claim 17, wherein the at least one actuator, is configured to move the locking element into the locking position and to release the locking element from the locking position, and wherein the locking element is configured to be reversibly fastened to the tank or the cover so as to effect the locking of the filer body.

19. The filtration housing assembly according to claim 18, wherein the holding means is configured for holding the locking element in the unlocking position.

20. The filtration housing assembly according to claim 18, wherein the holding means is configured to hold the actuator in the unlocking position.

21. The filtration housing assembly according to claim 17, wherein the actuator and the locking element are linked to one another by a mechanical articulation.

22. The filtration housing assembly according to claim 21, wherein the mechanical articulation comprises a knuckle joint.

23. The filtration housing assembly according to claim 22, wherein the knuckle joint defines a first axis, which is fixed in relation to the cover or the tank about which the actuator is at least partially movable in rotation, the knuckle joint defining a second axis which is fixed in relation to the actuator, the locking element being at least partially movable in rotation about the second axis.

24. The filtration housing assembly according to claim 17, wherein the actuator and the locking element are made of a single piece forming at least a portion of the locking system.

25. The filtration housing assembly according to any one of claim 17, wherein the locking element has a fastening part forming a hook on one end thereof, and wherein the tank or the cover has a part corresponding to the fastening part which is configured for enabling the retention of the fastening part in the locking position.

26. The filtration housing assembly according to claim 17, wherein at least one of the locking element and the actuator of the locking system comprises at least one wire.

27. The filtration housing assembly according to claim 17, wherein at least one of the locking element and the actuator comprises a plate.

28. The filtration housing assembly according to claim 17, wherein the locking element of the locking system comprises at least two wire portions, the at least two wire portions configured to be held on the outside or on the inside of the holding means in the unlocking position.

29. The filtration housing assembly according to claim 17, wherein at least one of the locking element and the actuator comprises a plate, and wherein the holding means is configured to hold at least one edge of the plate.

30. The filtration housing assembly according to claim 15, wherein the holding means is formed in or on one of the cover or the tank.

31. A filtration housing assembly, comprising:
a filter housing body comprising a tank and a cover, the filter body configured to house a filter cartridge;
at least one locking system coupled to one of the tank and the cover, the at least one locking system movable between a locking position and an unlocking position; and
a receiver coupled to the other of the tank and the cover, the receiver configured to at least selectively receive a portion of the locking system in the unlocking position.

32. The filtration housing assembly according to claim 31, wherein the least one locking system includes at least one locking element and an actuator, the at least one locking element engaging the receiver in the unlocking position.

33. The filtration housing assembly according to claim 32, wherein the receiver is a single piece receiver, and wherein the at least one locking element engages an inside surface of the receiver in the unlocking position.

34. The filtration housing assembly according to claim 32, wherein the receiver comprises a first receiver portion and a second receiver portion, and wherein the at least one locking element engages an inside surface of each of the first receiver portion and the second receiver portion.

35. The filtration housing assembly according to claim 32, wherein the receiver comprises a first receiver portion and a second receiver portion, and wherein the at least one locking element engages an outside surface of each of the first receiver portion and the second receiver portion.

36. The filtration housing assembly according to claim 32, wherein the first receiver portion and the second receiver portion are separate components which are not in direct contact with each other.

37. The filtration housing assembly according to claim 32, wherein the at least one locking element comprises a wire including a first wire portion and a second wire portion, the first wire portion and the second wire portion engaging at least one surface of the receiver in the unlocking position.

38. The filtration housing assembly according to claim 32, wherein the at least one locking comprises a plate, the plate engaging at least one surface of the receiver in the unlocking position.
